(19) United States
(12) Patent Application Publication
(10) Pub. No.: US 2018/0120104 A1
(43) Pub. Date: May 3, 2018

(54) Easy Assembly Level

(71) Applicant: Ching Lin Plastic Industry Co., Ltd., Taichung City (TW)

(72) Inventor: Wen-Hsin Liao, Taichung City (TW)

(21) Appl. No.: 15/854,170

(22) Filed: Dec. 26, 2017

Related U.S. Application Data
(63) Continuation-in-part of application No. 15/164,936, filed on May 26, 2016.

(51) Int. Cl. G01C 9/28; G01C 9/34

(52) U.S. Cl. CPC G01C 9/28; G01C 9/34

(57) ABSTRACT

An easy assembly level includes a body, a fixing assembly, and a bubble level vial. The body defines at least one compartment. The at least one bubble level vial is positioned within the at least one compartment. The at least one fixing assembly includes a first retainer and a second retainer connectable to the body and configured for jointly retaining the at least one bubble level vial within at least one compartment. The first and second retainers are fastened to the body by at least one rivet.

### CROSS REFERENCE TO RELATED APPLICATION

The present application is a continuation-in-part application of U.S. patent application Ser. No. 15/164,936 filed on May 26, 2016, of which the disclosure is incorporated herein.

### BACKGROUND OF THE INVENTION

### 1. Field of the Invention

The present invention relates to a level and, particularly, to an easy assembly level.

### 2. Description of the Related Art

TW Pat. No. M281167 shows a level including a body, a fixing assembly, and a bubble level vial. The bubble level vial is releasably fixed to the body by the fixing assembly. The fixing assembly includes a seat, two protective windows, and two retainers. The seat is disposed within the body and defines a space. The bubble level vial is positioned in the space. The bubble level vial is secured to the seat by a plurality of fasteners. The two protective windows combine together and capsulate the bubble level vial. The two retainers respectively receive the two protective windows and are releasably engaged with the body. However, the design of the level is complicated and it is not easy to assemble the level.

The present invention is, therefore, intended to obviate or at least alleviate the problems encountered in the prior art.

### SUMMARY OF THE INVENTION

According to the present invention, an easy assembly level includes a body, at least one fixing assembly, and at least one bubble level vial. The body defines at least one compartment. The at least one compartment extends through a first side and a second side of the body respectively. The at least one bubble level vial is positioned within the at least one compartment. The at least one fixing assembly includes a first retainer and a second retainer connectable to the body and configured for jointly retaining the at least one bubble level vial within at least one compartment. The first retainer is made of metal. The second retainer is made of metal. The first and second retainers are fastened to the body by at least one rivet. The first and second retainers each have a hole corresponding to the at least one rivet and configured for insertion of the at least one rivet. The body has a through hole corresponding to the at least one rivet and configured for insertion of the at least one rivet. When the first and second retainers are fastened to the body, the at least one rivet is inserted through the hole of first retainer, the through hole of the body, and the hole of second retainer sequentially.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

It is therefore an objective of the present invention to provide a level that has the advantage of easy assembly.

It is another objective of the present invention that the level can be assembled without the aid of tools.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of an easy assembly level in accordance with a first embodiment of the present invention.

FIG. 2 is an exploded perspective view of the easy assembly level of FIG. 1.

FIG. 3 is a cross-sectional view taken along line 3-3 of FIG. 1.

FIG. 4 is a cross-sectional view taken along line 4-4 of FIG. 1.

FIG. 5 is a perspective view of an easy assembly level in accordance with a second embodiment of the present invention.

FIG. 6 is an exploded perspective view of the easy assembly level of FIG. 5.

FIG. 7 is a cross-sectional view taken along line 7-7 of FIG. 5

### DETAILED DESCRIPTION OF THE INVENTION

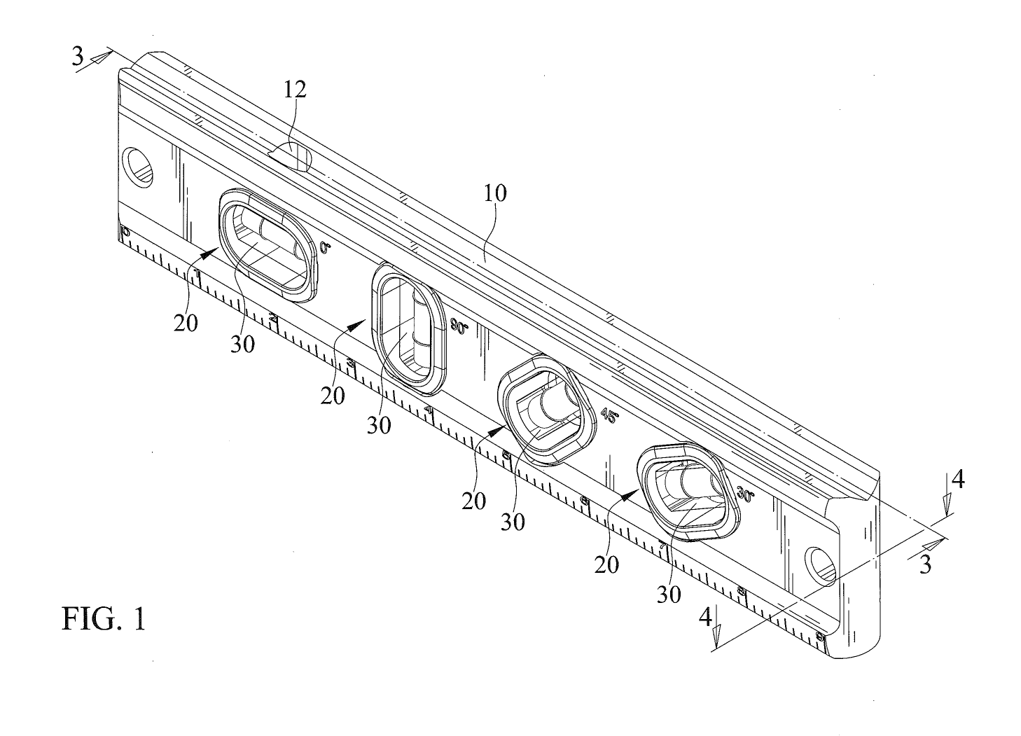

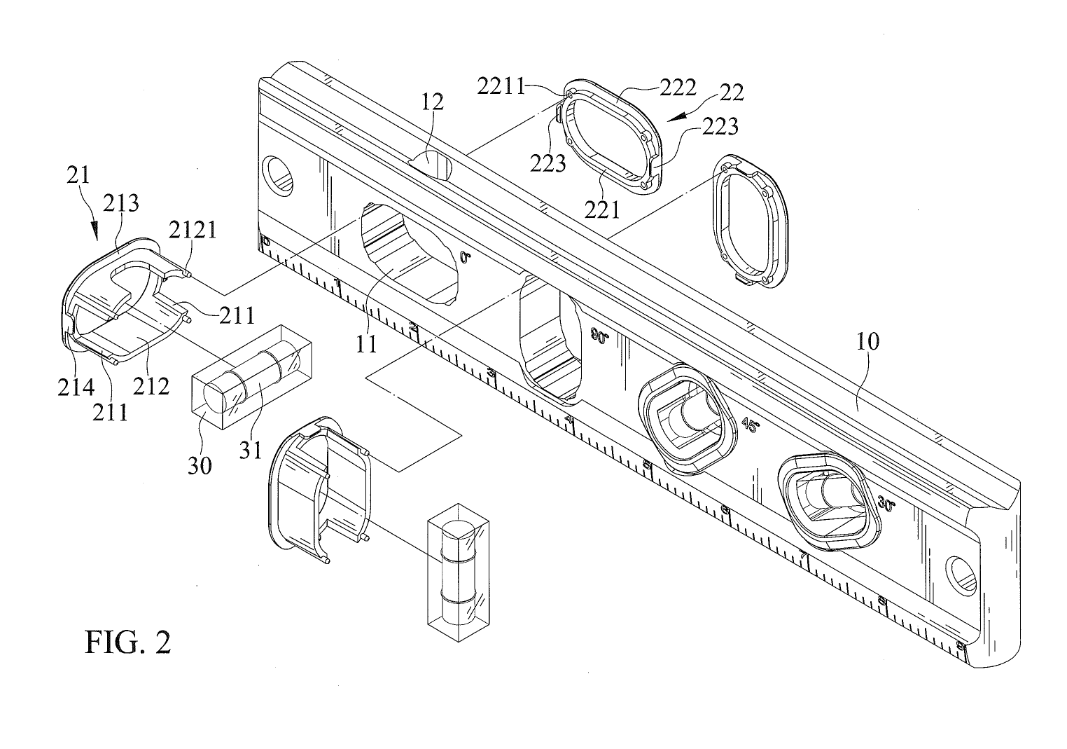

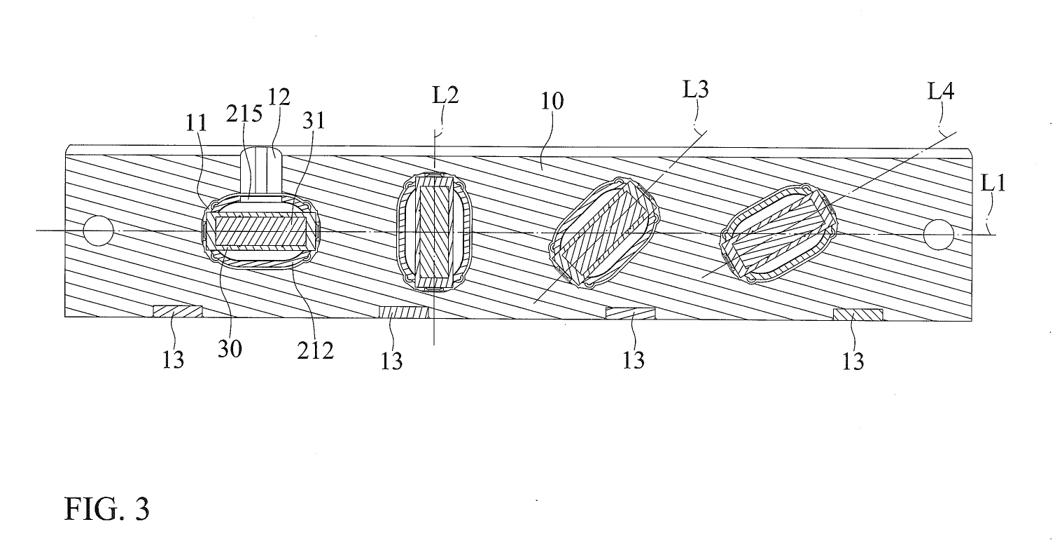

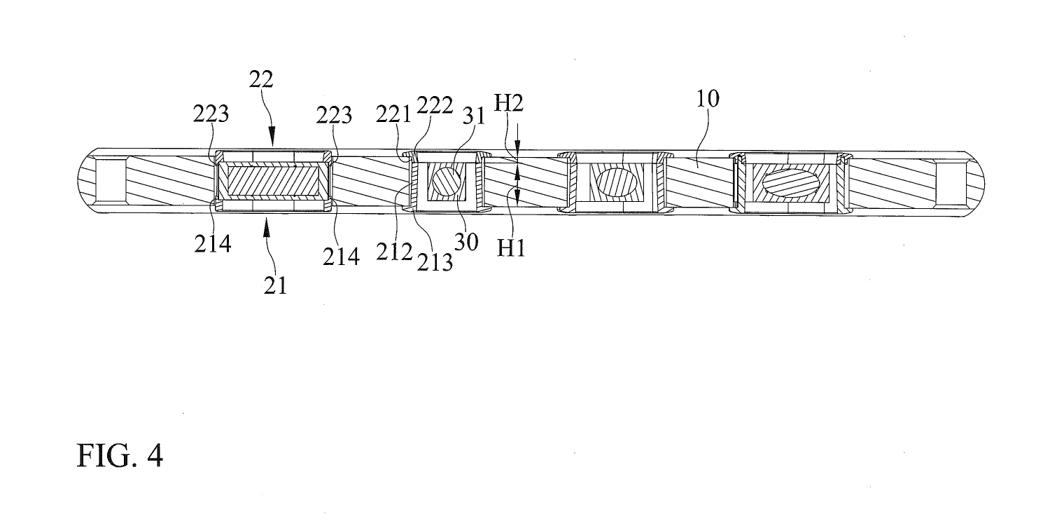

FIGS. 1 through 4 show an easy assembly level in accordance with a first embodiment of the present invention.

A body 10 forms a frame and is marked with units of measurement. The units of measurement are arranged along a length of the body 10. The body 10 defines at least one compartment 11. The at least one compartment 11 extends through the body 10. The at least one compartment 11 defines a first opening on a first side of the body 10 and a second opening on a second side of the body 10 respectively. The first and second sides form two opposite lateral sides of the body 10. The at least one compartment 11 extends transversely to a length direction of the body 10. Moreover, the body 10 has a third side and a fourth side opposing to one another and extending transversely to the first and second sides. The third and fourth sides respectively form upper and lower sides of the body 10. The at least one compartment 11 does extend through the upper and lower sides of the body 10. The body 10 also defines a viewing aperture 12 extending therethrough. The viewing aperture 12 extends through the third side of the body 10 to the at least one compartment 11.

At least one recess is formed in one of the third and fourth sides of the body 10. In the embodiment, the fourth side forms the at least one recess. The at least one recess includes at least one magnet 13 received therein. When the fourth side of the body 10 is placed on a metal surface, the fourth side can magnetically fix to the metal surface by the at least one magnet 13.

At least one fixing assembly 20 includes a first retainer 21 and a second retainer 22. The first and second retainers 21 and 22 are releasably connectable to the body 10. The first retainer 21 has a first wall 212 adapted to be inserted in the at least one compartment 11. When connecting the first retainer 21 with the at least one compartment 11, the first wall 212 is inserted through the first opening into the at least one compartment 11 and has a first length H1 received within the at least one compartment 11. The first retainer 21 forms a channel 211. The second retainer 22 has a second wall 221 adapted to be inserted in the at least one compartment 11. When connecting the second retainer 22 with the at least one compartment 11, the second wall 221 is inserted through the second opening into the at least one compartment 11 and has a second length H2 received within the at least one compartment 11. The first length H1 is greater than the second length H2.

The first retainer 21 has a first flange 213 extending radially outwardly from the first wall 212. When the first retainer 21 is connected to the body 10, the first side of the body 10 is abutted by the first flange 213. The first retainer 21 is inserted into the at least one compartment 11 until the first flange 213 abuts and is fit on the first side of the body 10. The second retainer 22 has a second flange 222 extending radially outwardly from the second wall 221. When the second retainer 22 is connected to the body 10, the second side of the body 10 is abutted by the second flange 222. The second retainer 22 is inserted into the at least one compartment 11 until the second flange 222 abuts and is fit on the second side of the body 10.

The first retainer 21 has two first stopping structures 214. One first stopping structure 214 is located adjacent to one of two opposite ends of the channel 211 and another first stopping structure 214 is located adjacent to another end of the channel 211 respectively.

The first retainer 21 has a first window extending therethrough. The first window is surrounded by the first wall 212. A user can see the at least one bubble level vial 30 through the first window. The first window is oriented transversely to the viewing aperture 12. The second retainer 22 has a second window extending therethrough. The second window is surrounded by the second wall 221. The user can also see the at least one bubble level vial 30 through the second window. The second window is oriented transversely to the viewing aperture 12. The first and second windows are located oppositely.

The first retainer 21 has a cavity 215. The cavity 215 is connected and opens to the channel 211 and the viewing aperture 12. Therefore, the user can also see the at least one bubble level vial 30 through the viewing aperture 12.

The first and second retainers 21 and 22 are releasably joinable to each other. The first retainer 21 has a first connecting structure 2121 and the second retainer 22 has a second connecting structure 2211 respectively. The first and second connecting structures 2121 and 2211 are releasably joinable with each other. One of the first and second connecting structures 2121 and 2211 forms at least one protrusion and another of first and second connecting structures 2121 and 2211 forms at least one hole. By engaging the first connecting structure 2121 with the second connecting structure 2211, the first and second retainers 21 and 22 are releasably joined together.

At least one bubble level vial 30 is received in channel 211 and positioned in the compartment 11. The channel 211 has two opposite open ends which form two slots on the first wall 212. The two slots are diametrically opposite to one another. The least one bubble level vial 30 has a first end received by one slot of the channel 211 and a second end received by another slot of the channel 211 respectively. The first and second retainers 21 and 22 are releasably joined together to encapsulate the at least one bubble level vial 30.

The at least one bubble level vial 30 is fixed to the body 10. The at least one bubble level vial 30 is retained in the channel 211 by the first stopping structures 214, with one first stopping structure 214 retraining the first end of the at least one bubble level vial 30 and another first stopping structure 214 retaining the second end of the at least one bubble level vial 30 respectively. The two first stopping structures 214 cooperate to releasably hold the at least one bubble level vial 30. The second retainer 22 defines two second stopping structures 223. One second stopping structures 223 is located adjacent to one first stopping structure 214 and another second stopping structure 223 is located adjacent to another first stopping structure 214 respectively. One second stopping structure 223 abuts against the first end of the at least one bubble level vial 30 and another second stopping structure 223 abuts against the second end of the at least one bubble level vial 30 respectively. The two second stopping structures 223 cooperate to releasably hold the at least one bubble level vial 30.

The at least one bubble level vial 30 has an outer body of rectangular cross section and an inner body 31 of tubular cross section. The at least one bubble level vial 30 has a liquid held by the inner body 31. The outer and inner bodies are transparent. The inner body 31 is incompletely filled with the liquid, thus creating a bubble in the inner body 31. The bubble can be seen through the outer body and the inner body 31. The bubble naturally rests in the center of the inner body 31 when the bubble level vial 30 is placed on a level surface and travels away from the center position when the bubble level vial 30 is placed on inclined surfaces.

In the embodiment, the at least one compartment 11 includes a plurality of compartments 11, the at least one fixing assembly 20 includes a plurality of fixing assemblies 20, and the at least one bubble level vial 30 includes a plurality of bubble level vials 30. The plurality of bubble level vials 30 is oriented at different angles. The plurality of bubble level vials 30 includes one bubble level vial 30 oriented at 0 degree and extends longitudinally along a first axis L1, another bubble level vial 30 oriented at 90 degrees and extends longitudinally along a second axis L2, another bubble level vial 30 oriented at 45 degrees and extends longitudinally along a third axis L3, and another bubble level vial 30 oriented at 30 degrees and extends longitudinally along a forth axis L4, respectively. The length of the body 10 extends longitudinally along the first axis L1. The second axis L2 is tilted perpendicular to the first axis L1. The third axis L3 is tilted at 45 degrees with respect to the first axis L1. The fourth axis L4 is titled at 30 degrees with respect to the first axis L1.

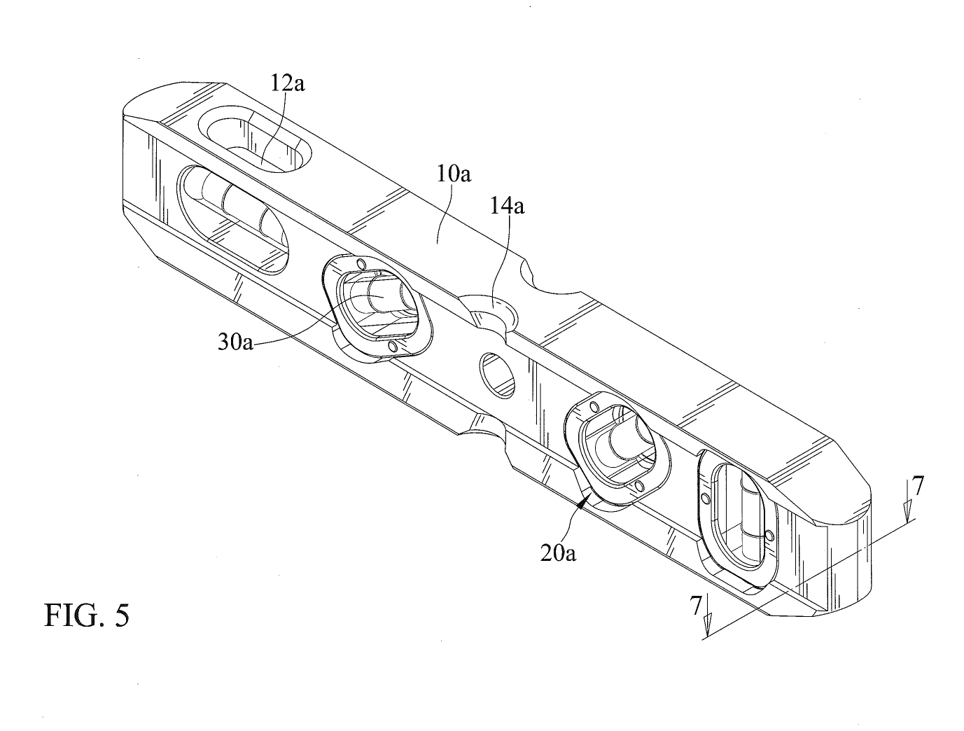

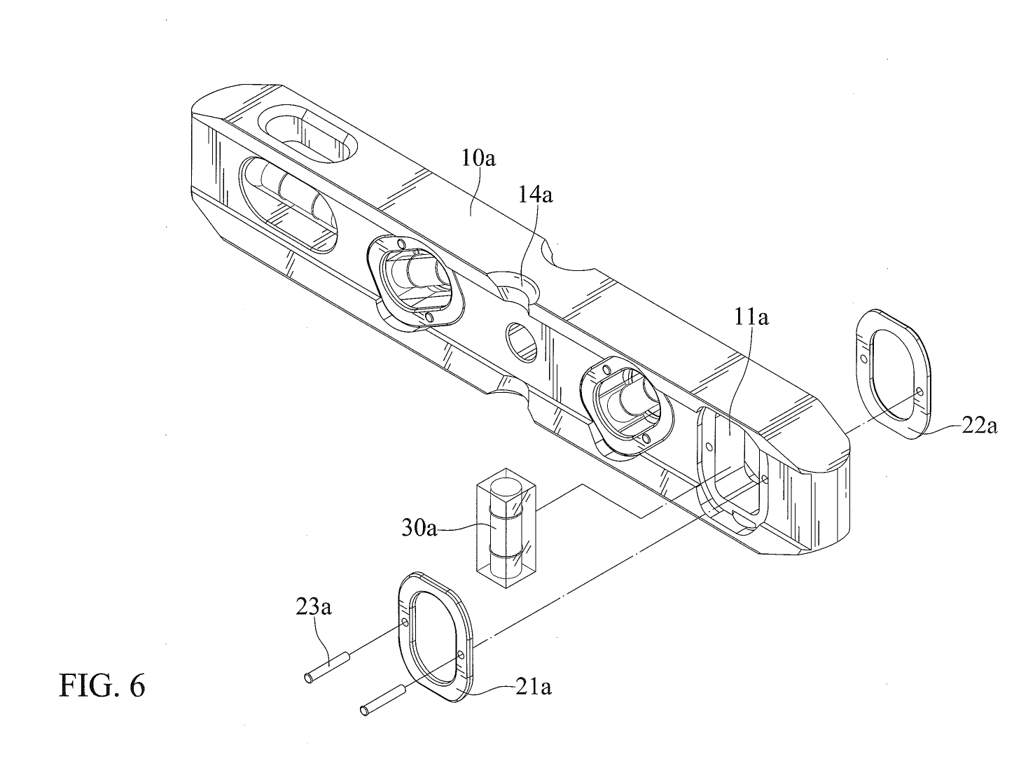

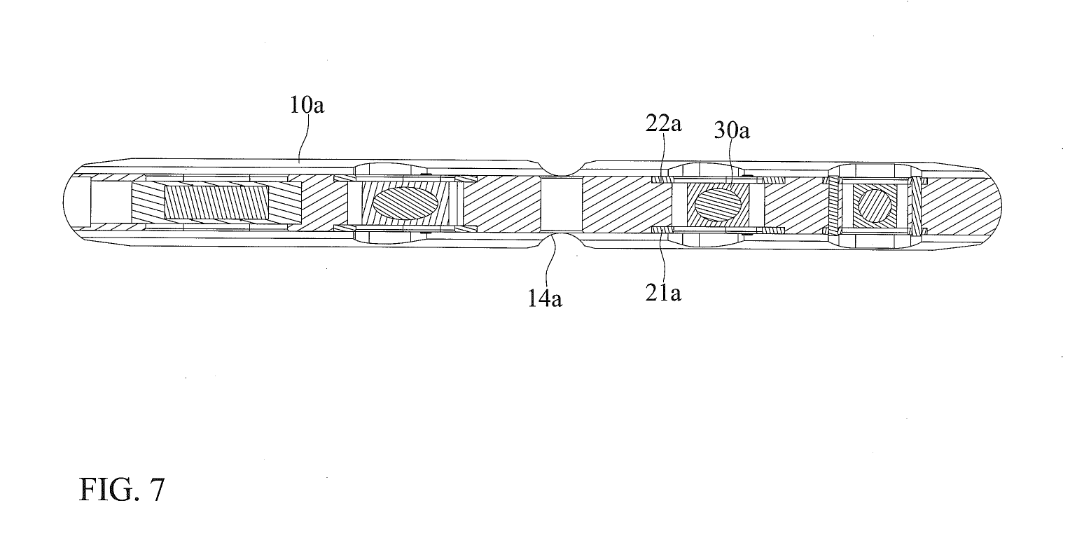

FIGS. 5 through 7 show an easy assembly level in accordance with a second embodiment of the present invention, and the same numbers are used to correlate similar components of the first embodiment, but bearing a letter a. The second embodiment has a body 10a, at least one fixing assembly 20a, and at least one bubble level vial 30a. The body 10a has first and second sides forming lateral sides, a third side forming an upper side, and a fourth side forming a lower side. The body 10a includes the third and fourth sides extending between the first and second sides. The body 10a defines at least one compartment 11a configured for receiving the at least one bubble level vial 30a and a viewing aperture 12a configured for allowing the user to see the at least one bubble level vial 30a as set forth in the first embodiment. The at least one compartment 11a extends through first and second sides of the body 10a. The viewing aperture 12a extends through the third side of the body 10a and opens to the at least one compartment 11a. The body 10a has at least one notch 14a formed therein for facilitating the user holding the body 10a ergonomically. The at least one notch 14a includes two pair of notches 14a located oppositely, with one pair of notches located adjacent to the upper side of the body 10a, and with another pair of notches located adjacent to the lower side of the body 10a.

The at least one fixing assembly 20a includes a first retainer 21a and a second retainer 22a connectable to the body 10a and configured for jointly retaining the at least one bubble level vial 30a within at least one compartment of the body 10a. The first retainer 21a is in a form of a plate. The first retainer 21a is made of metal. The second retainer 22a is in a form of a plate. The second retainer 22a is made of metal. The first retainer 21a has a window extending therethrough, and the window is open to at least one compartment of the body 10a and allows the user to see the at least one bubble level vial 30a located in the at least one compartment 11a as set forth in the first embodiment. The second retainer 22a has another window extending therethrough, and the window is open to at least one compartment 11a of the body 10a and allows the user to see the at least one bubble level vial 30a located in the at least one compartment as set forth in the first embodiment. The windows of the first and second retainers 21a and 22a are oriented transversely to the viewing aperture 12a.

The first retainer 21a and the second retainer 22a are fastened to the body 10a by at least one rivet 23a. The body 10a has a through hole corresponding to the at least one rivet 23a and configured for insertion of the at least one rivet 23a. The first retainer 21a has a hole corresponding to the at least one rivet 23a and configured for insertion of the at least one rivet 23a. The second retainer 22a has a hole corresponding to the at least one rivet 23a and configured for insertion of the at least one rivet 23a. Therefore, when the first and second retainers 21a and 22a are fastened to the body 10a, the at least one rivet 23a is inserted through the hole of first retainer 21a, the through hole of the body 10a, and the hole of second retainer 22a sequentially.

The first and second retainers 21a and 22a are respectively positioned on opposing first and second sides of the body 10a. The body 10a has a first groove for receiving the first retainer 21a and a second groove for receiving the second retainer 22a respectively. The through hole of the body 10a extends through a bottom wall of the first and second grooves. The first groove is positioned in a spaced relationship with the second groove. The first groove is formed in the first side of the body 10a and has a contour conforming to a contour of the first retainer 21a. The second groove is formed in the second side of the body 10a and has a contour conforming to a contour of the second retainer 22a.

The at least one bubble level vial 30a is the same as the at least one bubble level vial 30. The at least one bubble level vial 30a is positioned within the at least one compartment of the body 10a. In this embodiment, the at least one compartment includes a plurality of compartments, the at least one fixing assembly 20a includes a plurality of fixing assemblies 20a, and the at least one bubble level vial 30a includes a plurality of bubble level vials 30a. The plurality of bubble level vials 30 is oriented at different angles.

In view of the forgoing, the first and second retainers 21, 22, 21a, and 22a of the fixing assemblies 20 and 20a can be assembled without the aid of tools to hold the respective bubble level vials 30 and 30a. Moreover, the fixing assemblies 20 and 20a can be securely connected to the respective bodies 10 and 10a.

The foregoing is merely illustrative of the principles of this invention, and various modifications can be made by those skilled in the art without departing from the scope and spirit of the invention.

What is claimed is:

1. An easy assembly level comprising:
a body defining at least one compartment wherein the at least one compartment extending through a first side and a second side of the body respectively;
at least one bubble level vial positioned within the at least one compartment;
at least one fixing assembly including a first retainer and a second retainer connectable to the body and configured for jointly retaining the at least one bubble level vial within at least one compartment, wherein the first retainer is made of metal, wherein the second retainer is made of metal, wherein the first and second retainers are fastened to the body by at least one rivet, wherein the first and second retainers each have a hole corresponding to the at least one rivet and configured for insertion of the at least one rivet; and
wherein the body has a through hole corresponding to the at least one rivet and configured for insertion of the at least one rivet, and wherein when the first and second retainers are fastened to the body, the at least one rivet is inserted through the hole of first retainer, the through hole of the body, and the hole of second retainer sequentially.

2. The easy assembly level as claimed in claim 1, wherein the body has at least one notch formed therein for facilitating the user holding the body ergonomically.

3. The easy assembly level as claimed in claim 2, wherein the at least one notch includes two pair of notches located oppositely, with one pair of notches located adjacent to an upper side of the body, and with another pair of notches located adjacent to the lower side of the body.

4. The easy assembly level as claimed in claim 1, wherein the body defines a viewing aperture extending through a third side of the body and opening to the at least one compartment, wherein the body includes the third side extending between the first and second sides, and wherein viewing aperture extends transversely to the at least one compartment.

5. The easy assembly level as claimed in claim 1, wherein the first retainer has a first window extending therethrough and opening to at least one compartment, wherein the second retainer has a second window extending therethrough and opening to at least one compartment.

6. The easy assembly level as claimed in claim 10, wherein the body defines a viewing aperture extending through a third side of the body and opening to the at least one compartment, wherein the body includes the third side extending between the first and second sides, wherein viewing aperture extends transversely to the at least one compartment, and wherein the viewing aperture are oriented transversely to the first and second windows.

7. The easy assembly level as claimed in claim 1, wherein the body has a first groove formed in the first side for receiving the first retainer and a second groove formed in the second side for receiving the second retainer respectively, wherein the first groove is positioned in a spaced relationship with the second groove, wherein the first groove has a contour conforming to a contour of the first retainer and the second groove has a contour conforming to a contour of the second retainer 22a respectively.

8. The easy assembly level as claimed in claim 7, wherein the body has at least one notch formed therein for facilitating the user holding the body ergonomically.

9. The easy assembly level as claimed in claim 7, wherein the body defines a viewing aperture extending through a third side of the body and opening to the at least one compartment, wherein the body includes the third side extending between the first and second sides, and wherein viewing aperture extends transversely to the at least one compartment.

10. The easy assembly level as claimed in claim 9, wherein the body has at least one notch formed therein for facilitating the user holding the body ergonomically.

11. The easy assembly level as claimed in claim 1, wherein the at least one bubble level vial has an outer body of rectangular cross section and an inner body of tubular cross section, and wherein the at least one bubble level vial has a liquid held by the inner body.

12. The easy assembly level as claimed in claim 11, wherein the outer and inner bodies are transparent.

13. The easy assembly level as claimed in claim 1, wherein the at least one compartment includes a plurality of compartments, wherein the at least one fixing assembly includes a plurality of fixing assemblies, wherein the at least one bubble level vial includes a plurality of bubble level vials, and wherein the plurality of bubble level vials is oriented at different angles.

14. The easy assembly level as claimed in claim 13, wherein the body has a first groove formed in the first side for receiving the first retainer and a second groove formed in the second side for receiving the second retainer respectively, wherein the first groove is positioned in a spaced relationship with the second groove, wherein the first groove has a contour conforming to a contour of the first retainer and the second groove has a contour conforming to a contour of the second retainer 22a respectively.

15. The easy assembly level as claimed in claim 14, wherein the body has at least one notch formed therein for facilitating the user holding the body ergonomically.

16. The easy assembly level as claimed in claim 14, wherein the body defines a viewing aperture extending through a third side of the body and opening to the at least one compartment, wherein the body includes the third side extending between the first and second sides, and wherein viewing aperture extends transversely to the at least one compartment.

17. The easy assembly level as claimed in claim 16, wherein the body has at least one notch formed therein for facilitating the user holding the body ergonomically.
